(19) United States
(12) Patent Application Publication
(10) Pub. No.: US 2007/0202984 A1
(43) Pub. Date: Aug. 30, 2007

(54) Multi-speed transmission

(75) Inventor: Gerhard Gumpoltsberger, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/705,075

(22) Filed: Feb. 9, 2007

(30) Foreign Application Priority Data
Feb. 14, 2006 (DE) 10 2006 006 620.0

(51) Int. Cl. F16H 3/44

(52) U.S. Cl. 475/323

(57) ABSTRACT

A multi-speed transmission with six forward gears and one reverse gear having an input and output shaft, planetary gearsets, shafts and control elements. The input shaft couples the sun gear of gearset (P2) and detachably couples, via clutch (14) to shaft (4). Shaft (4) couples the carrier of gearset (P3), and via brake (04) couples the transmission housing and via clutch (46) couples shaft (6). Shaft (6) couples the sun gear of gearset (P2) and via clutch (36) couples shaft (5), which couples the ring gear of gearset (P1) and sun gear of gearset (P3). Shaft (3) couples the ring gear of gearset (P2) and the spider of gearset (P1) and via the brake (03) coupled the housing. Output shaft (2) couples the ring gear of gearset (P3). The sun gear of gearset (P1) is to the housing via shaft (0).

This application claims priority from German Application Serial No. 10 2006 006 620.0 filed Feb. 14, 2006.

### FIELD OF THE INVENTION

The present invention relates to a multi-speed transmission in planetary design, particularly an automatic transmission for a motor vehicle.

### BACKGROUND OF THE INVENTION

According to the state of the art, automatic transmissions, particularly for motor vehicles, comprise planetary gearsets, which are shifted using friction and/or control elements, such as clutches and brakes, and which are typically connected to a starting element that is subject to a slip effect and optionally provided with a converter lock-up clutch, for example a hydrodynamic torque converter or a fluid clutch.

A transmission of this type is described in EP 0 434 525 A1. It comprises substantially one input shaft and one output shaft, which are arranged parallel to each other, a double-ratio planetary gearset concentric with the output shaft and five control elements in the form of three clutches and two brakes, the selective operation of which in pairs determines the different gear ratios between the input shaft and the output shaft. This transmission has a front-mounted gearset and two power paths, so that by the selective engagement in pairs of the five control elements six forward gears are obtained.

In the first power path, two clutches are required for transmitting the torque from the front-mounted gearset to two elements of the double-ratio planetary gearset. These elements are provided in the direction of power flow substantially behind the front-mounted gearset in the direction of the double-ratio planetary gearset. In the second power path, a further clutch is provided, which detachably connects this path to a further element of the double-ratio planetary gearset. The clutches are arranged such that the inner disk carrier forms the output end.

Furthermore, from the published prior art U.S. Pat. No. 6,139,463 a compact multi-speed transmission in planetary design, particularly for a motor vehicle is known, which has two planetary gearsets and one front-mounted gearset as well as three clutches and two brakes. In this known multi-speed transmission, two clutches C-1 and C-3 are provided in a first power path for transmitting the torque from the front-mounted gearset to the two planetary gearsets. The outer disk carrier and/or the cylinder or piston and pressure compensation sides of the clutch C-3 are connected to a first brake B-1. Furthermore, the inner disk carrier of the third clutch C-3 is connected to the cylinder or piston and pressure compensation sides of the first clutch C-1, the inner disk carrier of the first clutch C-1 being arranged on the output side and connected to a sun gear of the third planetary gearset.

From the Applicant's DE 199 49 507 A1 a multi-speed transmission is also known, according to which on the drive shaft, two non-shiftable, front-mounted gearsets are provided, which on the output side generate two rotational speeds which, in addition to the rotational speed of the input shaft, can be selectively switched by engaging the control elements to a shiftable double planetary gearset acting upon the output shaft such that, for changing from one gear to the next higher or lower gear of the two actuated control elements, only one control element must be engaged or disengaged.

DE 199 12 480 A1 discloses an automatically shiftable motor vehicle transmission with three carrier-mounted planetary gearsets as well as three brakes and two clutches for switching between six forward gears and one reverse gear and with one drive shaft and one output shaft. The automatically shiftable motor vehicle transmission is configured such that the drive shaft is directly connected to the sun gear of the second planetary gearset and that the drive shaft can be connected via the first clutch to the sun gear of the first planetary gearset and/or via the second clutch to the first planetary gearset. Additionally or alternatively, the sun gear of the first planetary gearset can be connected via the first brake to the transmission housing and/or the first planetary gearset can be connected via the second brake to the housing and/or to the sun gear of the third planetary gearset, via the third brake.

Furthermore, DE 102 13 820 A1 discloses a multi-speed automatic transmission, comprising a first input path T1 of a first speed ratio, an input path T2, which has a larger speed ratio than the input path T1, a planetary gearset of four elements, wherein the four elements are a first element, a second element, a third element and a fourth element following an order of elements on a speed diagram, a clutch C-2 transmitting a rotation from the input path T2 to the first element S3, a clutch C-1 transmitting the rotation from the input path T2 to the fourth element S2, a clutch C-4 transmitting a rotation from the input path T1 to the first element, a clutch C-3 transmitting the rotation from the input path T1 to the second element C3, a brake B-1 engaging the fourth element, a brake B-2 engaging the second element, and an output member coupled to the third element R3.

Within the scope of the applicant's DE 101 15 983 A1, a multiple-ratio transmission is described, comprising a drive shaft that is connected to a front-mounted gearset, an output shaft that is connected to a rear-mounted gearset, and a maximum of seven control elements, through the selective shifting of which at least seven forward gears can be shifted without range shifts. The front-mounted gearset is formed by a front-mounted planetary gearset or a maximum of two non-shiftable front-mounted planetary gearsets connected to the first front-mounted planetary gearset, wherein the rear-mounted gearset is configured as a two- four-shaft transmission with two shiftable rear-mounted planetary gearsets and has four free shafts. The first free shaft of this two-spider four-shaft transmission is connected to the first control element, the second free shaft with the second and third control elements, the third free shaft with the fourth and fifth control elements and the fourth free shaft is connected to the output shaft. According to the invention, a multiple-ratio transmission with a total of six shifting elements is proposed, which connect the third free shaft or the first free shaft of the rear-mounted gearset additionally to a sixth shifting element. For a multi-ratio transmission with a total of seven control elements, it is proposed according to the invention that the third free shaft is additionally connected to a sixth control element D′ and the first free shaft additionally with a seventh control element.

Furthermore, the scope of the Applicant's DE 101 15987 describes a multi-stage reduction gear with at least seven gears. In addition to the input shaft and output shaft, this transmission comprises a non-engageable upstream gear and an engageable downstream gear in the form of a two- four-shaft transmission. The upstream gear comprises a first planetary gearset, which in addition to the input rotational speed of the input shaft also provides a second rotational speed, which may optionally be shifted to the downstream gear. The downstream gear comprises two engageable planetary gearsets, which can shift at least seven gears using the six shifting elements, forming two power paths. During each shifting operation, range shifts are advantageously avoided. A 9-gear multi-speed transmission is furthermore known from DE 29 36 969; it comprises eight control elements and four gearsets.

Automatic vehicle transmissions in planetary designs in general have previously been described in the state of the art on many occasions and undergo continuous development and improvement. These transmissions should have, for example, a sufficient number of forward gears as well as one reverse gear and a gear ratio that is excellently suited for motor vehicles, having a high overall spread as well as favorable progressive ratios. Furthermore, they should allow a high starting gear ratio in the forward direction and include a direct gear and additionally be suited for use both in passenger cars and in commercial vehicles. In addition, design and construction costs of these transmissions should be low, in particular require a small number of control elements, and avoid double-shifts when shifting sequentially, so that always only one control element is engaged when shifting in defined gear groups.

It is, therefore, the object of the present invention to propose a multi-speed transmission of the type mentioned above in which the design and construction costs are optimized and furthermore the efficiency in the main driving gears with regard to drag and gearing losses is improved. Furthermore, it is intended that low torque acts on the control elements and planetary gearsets in the multi-speed transmission according to the invention and that the rotational speeds of the shafts, control elements and planetary gearsets be kept as low as possible. In addition, the required number of gears and spread of the gear ratios should also be maintained, implementing advantageously six forward gears and at least one reverse gear. Furthermore, the transmission according to the invention should be suitable for any design in a vehicle, particularly for a frontal-transverse configuration.

### SUMMARY OF THE INVENTION

According to the invention, a multi-speed transmission in planetary design is proposed, which has one input shaft and one output shaft, which are arranged in a housing. Furthermore, at least three planetary gearsets—hereinafter referred to as the first, second and third planetary gearsets—, at least six rotatable shafts—hereinafter referred to as the input shaft, output shaft, third, fourth, fifth and sixth shafts—and at least five control elements, comprising brakes and clutches, are provided; the selective engagement of these control elements produces different gear ratios between the input shaft and output shaft so that preferably six forward gears and one reverse gear can be shifted.

The input shaft is permanently connected to the sun gear of the second planetary gearset and can be detachably connected via a clutch to the fourth shaft, wherein the fourth shaft is permanently connected to the third planetary gearset, can be coupled to the housing via a brake and can be detachably connected via another clutch to the sixth shaft.

According to the invention, the sixth shaft is permanently connected to the second planetary gearset and can be detachably connected via a clutch to the fifth shaft, wherein the fifth shaft is permanently connected to the ring gear of the first planetary gearset and the sun gear of the third planetary gearset. Furthermore, the third shaft is permanently connected to the ring gear of the second planetary gearset and the first planetary gearset and can be coupled to the housing via a brake.

Furthermore the output shaft is permanently connected to the ring gear of the third planetary gearset, wherein the sun gear of the first planetary gearset is connected non-rotatably to the housing via a non-rotating shaft.

The configuration of the multi-speed transmission according to the invention produces suitable gear ratios particularly for passenger cars as well as a considerable increase in the total spread of ratios of the multi-speed transmission, resulting in improved driving comfort and a significant improvement in fuel economy.

In addition, with the multi-speed transmission according to the invention the reduced amount of shifting elements, preferably two brakes and three clutches, the design and construction costs are significantly low. It is advantageously possible with the multi-speed transmission according to the invention to start the vehicle with a hydrodynamic converter, a hydrodynamic clutch, an external starting clutch or with other suitable external starting elements. It is also conceivable to initiate a start operation with a starting element integrated in the transmission. A control element, which is actuated in the first gear and in the reverse gear, is preferred.

In addition, good efficiency in the main driving gears with regard to drag and gearing losses can be achieved with the multi-speed transmission according to the invention.

Furthermore, low torque is present in the control elements and in the planetary gearsets of the multi-speed transmission, thus advantageously reducing the wear on the multi-speed transmission. In addition, the low torque makes correspondingly small dimensions possible, allowing reductions in the required installation space and corresponding expenses. Also, the rotational speeds in the shafts, control elements and planetary gearsets are low.

In addition, the transmission according to the invention is designed such that it can be adjusted to different drive train configurations, both in the direction of power flow and with regard to space.

### BRIEF DESCRIPTION OF THE DRAWINGS

The invention will now be described, by way of example, with reference to the accompanying drawings in which:

FIG. 1 is a schematic view of a preferred embodiment of a multi-speed transmission according to the invention;

FIG. 2 is an exemplary shifting pattern for the multi-speed transmission according to the invention from FIG. 1;

FIG. 3 is a diagrammatic view of an embodiment of the inventive mutli-speed transmission having a one-way clutch;

FIG. 4 is a diagrammatic view of an embodiment of the inventive mutli-speed transmission with one electric machine;

FIG. 5 is a diagrammatic view of a preferred design of the inventive multi-speed transmission having a wear-free brake;

FIG. 6 is a diagrammatic view of a further embodiment of the invention with the input and the output being provided on the same side of the housing;

FIG. 7 is a diagrammatic view of another embodiment of the inventive multi-speed transmission with the crankshaft of the drive motor fixed to the input shaft of the multi-speed transmission and the driving element located behind the multi-speed transmission;

FIG. 8 is a diagrammatic view of an embodiment of the inventive multi-speed transmission having a differential;

FIG. 9 is a diagrammatic view of an embodiment of the inventive multi-speed transmission with a clutch element and a drive motor;

FIG. 10 is a diagrammatic view of an embodiment of the inventive multi-speed transmission with a crankshaft of the drive motor fixed to an input shaft of the multi-speed transmission;

FIG. 11 is a diagrammatic view of an embodiment of the inventive multi-speed transmission having the drive motor communicating with a damper;

FIG. 12 is a diagrammatic view of an embodiment of the inventive multi-speed transmission with a power take-off for driving an additional unit.

### DETAILED DESCRIPTION OF THE INVENTION

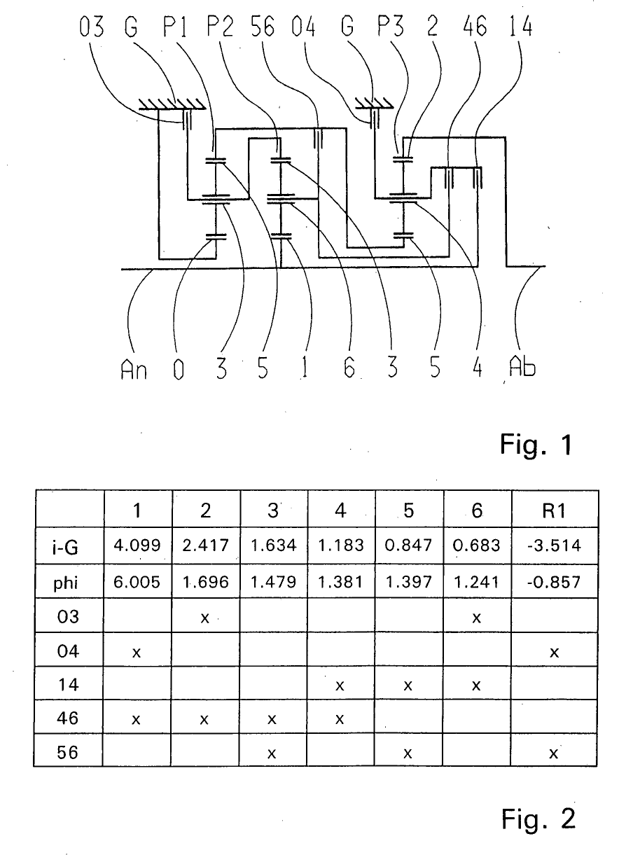

FIG. 1 shows a multi-speed transmission according to the invention comprising an input shaft 1 (An) and an output shaft 2 (Ab), which are arranged in a housing G. Three planetary gearsets P1, P2, P3 are provided, which are preferably configured as negative planetary gearsets and arranged in the sequence P1, P2, P3 in the axial direction.

As is apparent from FIG. 1, only five control elements, namely two brakes 03, 04 and three clutches 14, 46, and 56, are provided. With these control elements, a selective engagement of preferably six forward gears and one reverse gear can be implemented. The multi-speed transmission according to the invention has a total of six rotatable shafts, namely the shafts 1, 2, 3, 4, 5 and 6.

According to the invention, it is provided in the multi-speed transmission according to FIG. 1 that the input occurs via the shaft 1, which is permanently connected to the sun gear of the second planetary gearset P2 and can be detachably connected, via a clutch 14, to the shaft 4, wherein the shaft 4 is permanently connected to the third planetary gearset P3, can be coupled to the housing G, via the brake 04, and can be detachably coupled to the shaft 6, via the clutch 46.

According to the invention, the shaft 6 is permanently connected to the second planetary gearset P2 and can be detachably connected, via a clutch 56, to the shaft 5, wherein the shaft 5 is permanently connected to the ring gear of the first planetary gearset P1 and the sun gear of the third planetary gearset P3. Furthermore, the shaft 3 is permanently connected to the ring gear of the second planetary gearset P2 and the first planetary gearset P1 and can be coupled to the housing G, via the brake 3.

The output occurs via the shaft 2, which is permanently connected to the ring gear of the third planetary gearset P3. Furthermore, the sun gear of the first planetary gearset P1 is rotationally fixed to the housing G, via the shaft 0.

Within the scope of the illustrated embodiments, the clutches 46 and 14 are arranged behind the third planetary gearset P3 in the sequential order of 46, 14 from an axial point of view in the power flow direction and may have a common outer disk carrier as disk clutches.

The layout of the control elements can be arbitrary and is only limited by the dimensions and shape.

FIG. 2 shows, by way of example, a shifting pattern of the multi-speed transmission according to the invention from FIG. 1. For each gear, two control elements are engaged. The shifting pattern shows, by way of example, the respective gear ratios i of the individual gear steps and the resulting progressive ratios phi. Typical stationary gear ratio values of the planetary gearsets P1, P2, P3 are −3.005, −2.540 and −2.150, respectively. The shifting pattern also shows that double-shifts and/or range shifts are avoided when shifting sequentially because two adjoining gear steps jointly use one control element.

The first gear is defined by engaging the brake 04 and clutch 46, the second gear by engaging the brake 03 and clutch 46 and the third gear is defined by engaging the clutches 56 and 46. Furthermore, the fourth gear is defined by engaging the clutch 14 and clutch 46, the fifth gear by engaging the clutches 14 and 56, and the sixth gear by engaging the brake 03 and clutch 14. As the shifting pattern shows, the reverse gear is defined by engaging the brake 04 and clutch 56.

According to the invention, starting with an integrated control element 04,46 is possible (IAK), for which particularly the brake 04 is suited, which is required in the first gear and reverse gear. Furthermore, depending on the shifting logic, different gear steps may be obtained from the same gear pattern, allowing custom-designed and/or vehicle-specific variations.

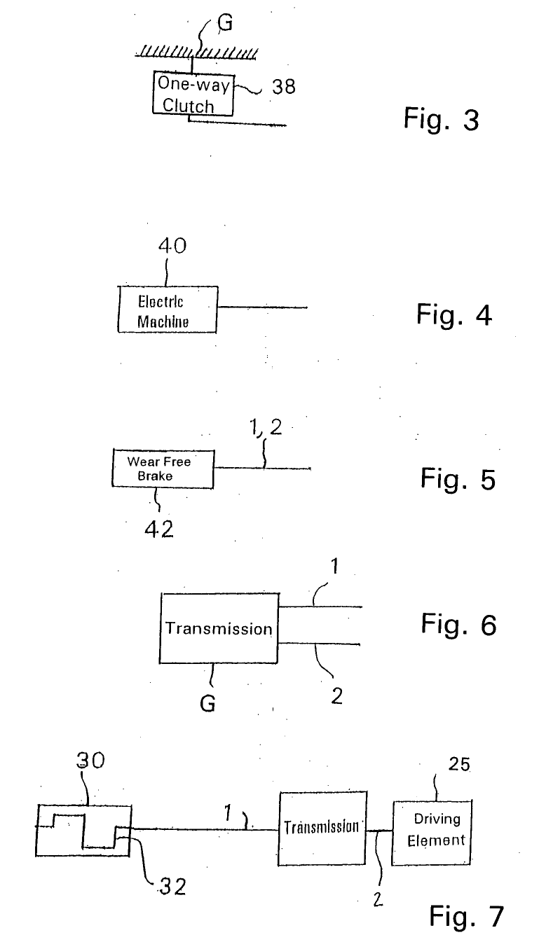

It is additionally possible, as shown in FIG. 3, to provide a one-way clutch 38 in suitable locations of the multi-speed transmission, for example between a shaft and the housing, or to optionally connect two shafts.

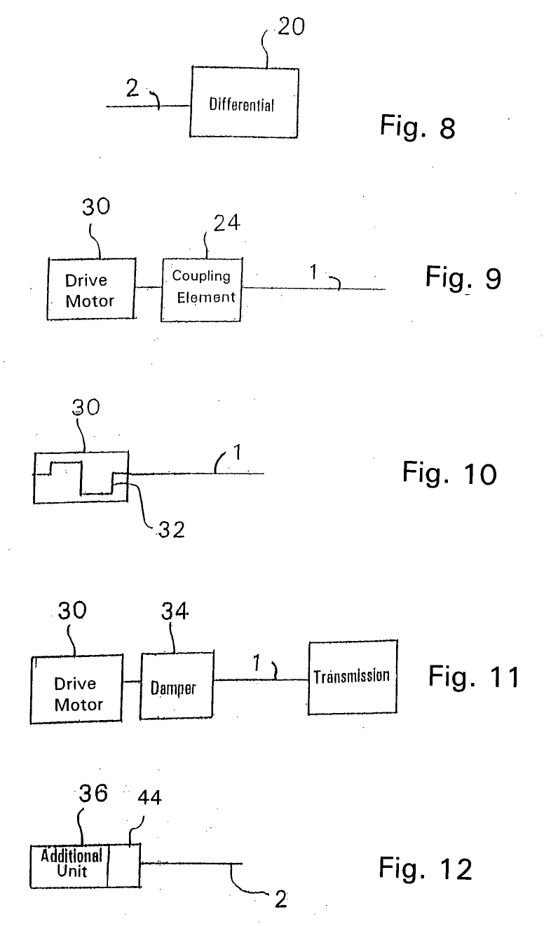

An axle differential and/or a transfer case differential 20 may be provided on the input side or on the output side according to the invention, as shown in FIG. 8.

Within the scope of an advantageous further development, as shown in FIG. 9, the input shaft 1 may be separated from the drive motor as needed by a coupling element 24, wherein the coupling element may be a hydrodynamic converter, a hydraulic clutch, a dry starting clutch, a wet starting clutch, a magnetic powder clutch or a centrifugal clutch. It is also possible to provide, as shown in FIG. 7 such a starting (driving) element 25 in the direction of power flow behind the transmission, wherein in this case, as shown in FIG. 10, the input shaft 1 is permanently connected to the crankshaft 32 of the engine (drive motor) 30.

The multi-speed transmission according to the invention, shown in FIG. 11 also allows to provide a torsional vibration damper 34 between the engine 30 and transmission.

Within the scope of a further embodiment of the invention, shown in FIG. 5, a wear-free brake 42, such as a hydraulic or electric retarder or the like, may be arranged on each shaft, preferably on the input shaft 1 or the output shaft 2, which is particularly important when the transmission is used in commercial vehicles. Furthermore, as shown in FIG. 12, a power take-off 44 may be provided on each shaft, preferably on the input shaft 1 or the output shaft 2, to drive additional units 36. Additionally, as shown in FIG. 6, the input and output shafts are provided on the same side of the housing.

The control elements used may be configured as power-shift clutches or brakes. In particular, power-shift clutches or brakes such as multi-disk clutches, band brakes and/or cone clutches may be used. Furthermore, it is also possible to use positive brakes and/or clutches, such as synchronization devices or claw clutches as control elements.

A further advantage of the multi-speed transmission presented here and shown in FIG. 4 is that an electric machine 40 can be provided on each shaft as a generator and/or as an additional drive unit.

Of course, any constructive embodiment, particularly any spatial arrangement of the planetary gearsets and control elements as such as well as in relation to each other, to the extent they are technically expedient, falls under the scope of protection of the present claims, without influencing the function of the transmission as described in the claims, even if these embodiments are not explicitly illustrated in the Figures or mentioned in the description.

### REFERENCE NUMERALS

0 shaft 38 one-way clutch
1 shaft 40 electric machine
2 shaft 42 wear-free brake
3 shaft 44 power take off
4 shaft 46 clutch
5 shaft 56 clutch
6 shaft
03 brake P1 planetary gearset
04 brake P2 planetary gearset
14 clutch P3 planetary gearset
20 differential An input
24 clutch element Ab input
25 driving element
30 drive motor i gear ratio
32 crank shaft IAK integrated control element
34 damper phi progressive ratio
36 additional unit G housing

1-23. (canceled)

24. A multi-speed automatic transmission of a planetary design for a motor vehicle, the transmission comprising:
an input shaft (1) and an output shaft (2) arranged in a housing (G);
first, second and third planetary gear sets (P1, P2, P3), and each of the first, the second and the third planetary gear sets (P1, P2, P3) comprising a sun gear, a carrier and a ring gear;
at least third, fourth, fifth and sixth rotatable shafts (1, 2, 3, 4, 5, 6) as well as at least five control elements (03, 04, 14, 46, 56), comprising first and second brakes (03, 04) and first, second and third clutches (14, 46, 56), whose selective engagement creates different gear ratios between the input shaft (1) and the output shaft (2) so that at least six forward gears and one reverse gear can be implemented;
wherein the input shaft (1) is permanently connected to the sun gear of the second planetary gear set (P2) and is detachably connected, via the first clutch (14), to the fourth shaft (4);
the fourth shaft (4) is permanently connected to the carrier of the third planetary gear set (P3), and detachably connectable, via the second brake (14), to the housing (G) and, via the second clutch (46), to the sixth shaft (6);
the sixth shaft (6) is permanently connected to the carrier of the second planetary gear set (P2) and detachably connectable, via the third clutch (56), to the fifth shaft (5);
the fifth shaft (5) is permanently connected to the ring gear of the first planetary gear set (P1) and the sun gear of the third planetary gear set (P3);
the third shaft (3) is permanently connected to the ring gear of the second planetary gear set (P2) and the carrier of the first planetary gear set (P1) and is detachably connectable, via the first brake (03), to the housing (G);
the output shaft (2) is permanently connected to the ring gear of the third planetary gear set (P3); and
the sun gear of the first planetary gear set (P1 ) is rotationally fixed, via an additional shaft (0), to the housing (G).

25. The multi-speed transmission according to claim 24, wherein the first, the second and the third planetary gear sets (P1, P2, P3) are arranged in an axial direction in the following sequential order:
the first planetary gear set (P1), the second planetary gear set (P2) and the third planetary gear set (P3).

26. The multi-speed transmission according to claim 24, wherein the first, the second and the third planetary gear sets (P1, P2, P3) are negative planetary gear sets.

27. The multi-speed transmission according to claim 24, wherein from an axial point of view, the second and the first clutches (46, 14) are arranged behind the third planetary gearset (P3), in a direction of power flow, in the following sequential order of the second clutch (46) and the first clutch (14).

28. The multi-speed transmission according to claim 24, wherein the second and the third clutches (46,14) have a common outer disk carrier.

29. The multi-speed transmission according to claim 24, wherein a first gear results from engagement of the second brake (04) and the second clutch (46), a second gear results from engagement of the first brake (03) and the second clutch (46), a third gear results from engagement of the third and the second clutches (56 and 46), a fourth gear results from engagement of the first clutch (14) and the second clutch (46), a fifth gear results from engagement of the first and the third clutches (14 and 56), and a sixth gear results from engagement of the first brake (03) and the first clutch (14).

30. The multi-speed transmission according to claim 24, wherein the reverse gear results from engagement of the second brake (04) and the third clutch (56).

31. The multi-speed transmission according to claim 24, wherein at least one one-way clutch is located within the transmission.

32. The multi-speed transmission according to claim 31, wherein the at least one one-way clutch is located between the input shaft (1), the output shaft (2), the third shaft (3), the fourth shaft (4), the fifth shaft (5), and the sixth shaft (6) and the housing (G).

33. The multi-speed transmission according to claim 24, wherein an input and an output of the transmission are located on a common side of the housing (G).

34. The multi-speed transmission according to claim 24, wherein at least one of an axle differential and a transfer case differential is located on one of the input shaft (1) and the output shaft (2).

35. The multi-speed transmission according to claim 24, wherein a coupling element facilitates separation of the input shaft (1) from a drive motor.

36. The multi-speed transmission according to claim 35, wherein the coupling element is one of a hydrodynamic converter, a hydraulic clutch, a dry starting clutch, a wet starting clutch, a magnetic powder clutch and a centrifugal clutch.

37. The multi-speed transmission according to claim 24, wherein an external driving element is located downstream of the transmission, in a direction of power flow, and the input shaft (1) is firmly connected to a crankshaft of a drive motor.

38. The multi-speed transmission according to claim 24, wherein the vehicle is started via one of the five control elements (04, 46) of the transmission, and the input shaft (1) is permanently connected to a crankshaft of a drive motor.

39. The multi-speed transmission according to claim 24, wherein a torsional vibration damper is located between a drive motor and the transmission.

40. The multi-speed transmission according to claim 24, wherein a wear-free brake is arranged on at least one of the input shaft (1), the output shaft (2), the third shaft (3), the fourth shaft (4), the fifth shaft (5), and the sixth shaft (6).

41. The multi-speed transmission according to claim 24, wherein a power take-off is arranged on at least one of the input shaft (1), the output shaft (2), the third shaft (3), the fourth shaft (4), the fifth shaft (5), and the sixth shaft (6) for driving an additional unit.

42. The multi-speed transmission according to claim 41, wherein the additional unit is arranged on one of the input shaft (1) and the output shaft (2).

43. The multi-speed transmission according to claim 24, wherein the five control elements are one of power-shift clutches and power-shift brakes.

44. The multi-speed transmission according to claim 43, wherein the five control elements are one of multi-disk clutches, band brakes and cone clutches.

45. The multi-speed transmission according to claim 24, wherein the five control elements are one of positive clutches and positive brakes.

46. The multi-speed transmission according to claim 24, wherein an electric machine is arranged at least one of the input shaft (1), the output shaft (2), the third shaft (3), the fourth shaft (4), the fifth shaft (5), and the sixth shaft (6) as one of a generator and an additional drive unit.
